(19) United States
(12) Patent Application Publication
(10) Pub. No.: US 2014/0122913 A1
(43) Pub. Date: May 1, 2014

(54) DEBUGGING DEVICE

(71) Applicants: INVENTEC (PUDONG) TECHNOLOGY CORPORATION, Shanghai (CN); INVENTEC CORPORATION, Taipei (TW)

(72) Inventor: Chih-Lung Lin, Taipei (TW)

(73) Assignees: INVENTEC CORPORATION, Taipei (TW); INVENTEC (PUDONG) TECHNOLOGY CORPORATION, Shanghai (CN)

(21) Appl. No.: 13/793,772

(22) Filed: Mar. 11, 2013

(30) Foreign Application Priority Data
Oct. 31, 2012 (CN) 201210427431.7

(51) Int. Cl. G06F 1/26; G06F 1/30

(52) U.S. Cl. CPC G06F 1/26; G06F 1/30
USPC 713/340

(57) ABSTRACT

A debugging device includes a power detection unit used for detecting a power supply status of a power supply unit of a server to generate a power detection signal, a boot status detection unit, a control unit, a first display unit and a second display unit. The boot status detection unit is coupled to a control chip, for receiving a boot inspection signal to generate a boot status detection signal. The control unit is coupled to the power detection unit and the boot status detection unit, for receiving the power detection signal and the boot status detection signal to generate a plurality of first control signals and a second control signal. The first display unit is coupled to the control unit, for receiving and displaying the first control signals. The second display unit is coupled to the control unit, for receiving and displaying the second control signal.

### CROSS-REFERENCE TO RELATED APPLICATIONS

This non-provisional application claims priority under 35 U.S.C. §119(a) on Patent Application No(s). 201210427431.7 filed in China on Oct. 31, 2012, the entire contents of which are hereby incorporated by reference.

### BACKGROUND OF THE INVENTION

1. Technical Field of the Invention

The disclosure relates to a debugging device, and more particularly to a debugging device adapted to a server.

2. Description of Related Art

When a present server is started, a basic input output system (BIOS) is first activated to inspect and test hardware apparatuses in the server, and this inspection and test operation is also called power on self test (POST). After the hardware apparatuses in the server pass the inspection and test operation, the BIOS delivers the hardware information in the server to an operating system, and the operating system continues to complete the boot process. However, if an error occurs in a certain part of the server, the boot process is held back and cannot be continued.

Therefore, in the case that an error occurs in booting process before the operating system, as long as the code of a particular input/output (IO) port, for example, Port 80, and an examination stage corresponding to the code are found, the part of the computer in which an anomaly occurs can be detected. The most commonly used debugging method is to use a debug card to capture the code of the Port 80.

Currently, the debug card is provided with a plurality of jumpers and a plurality of light-emitting diodes (LEDs), and switches display modes via the jumpers, so as to acquire the code of the Port 80 and a power sequence through the display status of the LEDs, thereby finding out which component in the server an error occurs in. However, the debug card only has two debugging modes, namely, the code of the Port 80 and the power sequence, and the jumpers are required to switch the display modes, so that the debugging efficiency is reduced.

### SUMMARY OF THE INVENTION

The disclosure provides a debugging device adapted to a server comprising a power supply unit and a control chip. The debugging device comprises a power detection unit, a boot status detection unit, a control unit, a first display unit and a second display unit. The power detection unit is coupled to the power supply unit of the server, and detects a power supply status of the power supply unit to generate a power detection signal. The boot status detection unit is coupled to the control chip, and receives a boot inspection signal to generate a boot status detection signal. The control unit is coupled to the power detection unit and the boot status detection unit, and receives the power detection signal and the boot status detection signal to generate a plurality of first control signals and a second control signal. The first display unit is coupled to the control unit, and receives and displays the first control signals. The second display unit is coupled to the control unit, and receives and displays the second control signal.

In an embodiment, the first display unit comprises a plurality of first LEDs and a plurality of first resistors. Cathode terminals of the first LEDs are coupled to the control unit and receive the first control signals. First terminals of the first resistors are one-to-one coupled to anode terminals of the first LEDs, and second terminals of the first resistors are supplied with a duty voltage.

In an embodiment, the second display unit comprises a second LED and a second resistor. A cathode terminal of the second LED is coupled to the control unit and receives the second control signal. A first terminal of the second resistor is coupled to an anode terminal of the second LED, and a second terminal of the second resistor is supplied with a duty voltage.

In an embodiment, the boot status detection unit receives the boot inspection signal generated by the control chip, through a low pin count (LPC) interface.

In an embodiment, the power supply unit starts supplying power, the server is started with an AC power and a DC power, the power detection unit generates the corresponding power detection signal to the control unit if the power supply status of the power supply unit is normal, and the control unit correspondingly outputs high logic levels of the first control signals to make the first display unit being in an on-status, and outputs a low logic level of the second control signal to make the second display unit being in an off-status, so as to indicate that the server is in a power sequence stage.

In an embodiment, when the control chip generates the boot inspection signal, the boot status detection unit outputs the boot status detection signal to the control unit in response to the boot inspection signal, and according to the boot status detection signal, the control unit correspondingly outputs a high logic level of the second control signal to make the second display unit being in an on-status, and outputs the first control signals corresponding to the boot status detection signal to make the first display unit present a display status corresponding to the boot status detection signal, so as to indicate that the server enters a POST stage.

In an embodiment, when an error occurs in the power supply unit, the power detection unit detects that the power supply status of the power supply unit is abnormal and then outputs the corresponding power detection signal to the control unit, and according to the power detection signal, the control unit correspondingly outputs low and high logic levels of the first control signals repeatedly and sequentially to make the first display unit being in a flickering status, and outputs a low logic level of the second control signal to make the second display unit being in an off-status, so as to indicate that the error occurs in the power supply unit.

In an embodiment, when the server is started with an AC power, the power detection unit outputs the power detection signal carrying an AC message to the control unit, and the control unit generates high logic levels of the first control signals sequentially to make the first display unit being in a running strip status, and generates a low logic level of the second control signal to make the second display unit being in an off-status, so as to indicate that the server is waiting to be started with a DC power.

### BRIEF DESCRIPTION OF THE DRAWINGS

The present disclosure will become more fully understood from the detailed description given herein below for illustration only, and thus does not limit the present disclosure, wherein:

FIG. 1 is a schematic view of a debugging device according to the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

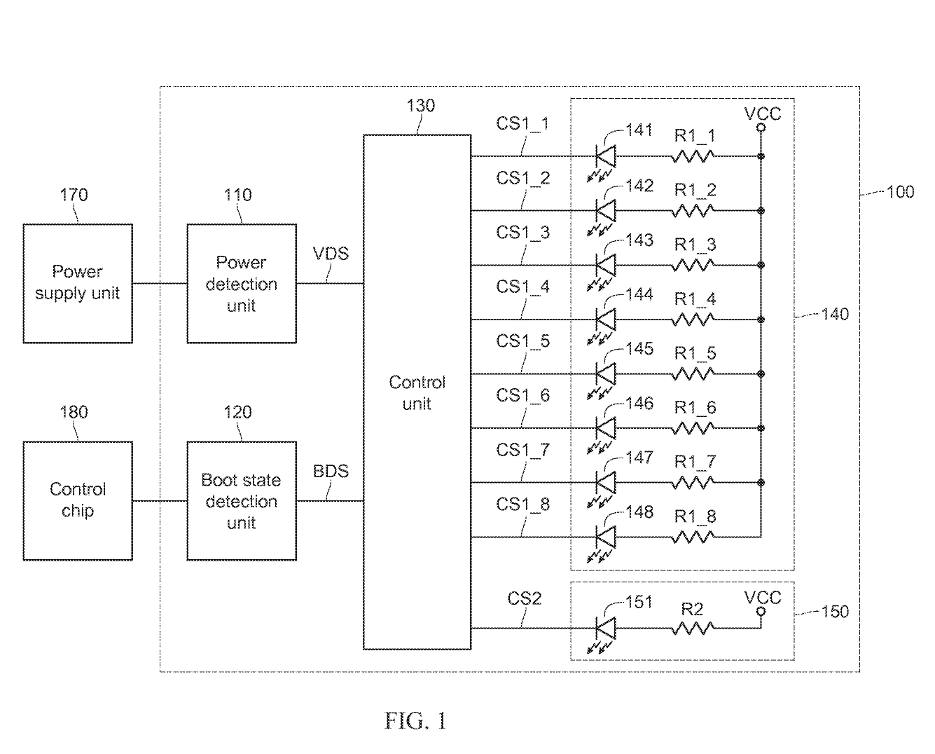

FIG. 1 is a schematic view of a debugging device according to the disclosure. The debugging device 100 of this embodiment is adapted to a server comprising a power supply unit 170 and a control chip 180. The debugging device 100 comprises a power detection unit 110, a boot status detection unit 120, a control unit 130, a first display unit 140 and a second display unit 150.

The power detection unit 110 is coupled to the power supply unit 170 of the server. The power supply unit 170 is, for example, used for providing a working power required by the server. In this and some embodiments, the power supply unit 170 provides a main power and a standby power.

The power detection unit 110 detects a power supply status of the power supply unit 170 to generate a power detection signal. For example, when the power detection unit 110 detects that the power supply status of the power supply unit 170 is normal, the power detection unit 110 generates a high logic level of a power detection signal VDS. Otherwise, when the power detection unit 110 detects that the power supply status of the power supply unit 170 is abnormal, the power detection unit 110 generates a low logic level of a power detection signal VDS.

The boot status detection unit 120 is coupled to the control chip 180. The control chip 180 is, for example, a south bridge (SB) chip or a platform controller hub (PCH) chip on a mainboard of a server.

In actual applications, a basic input output system (BIOS) memory pre-stores a plurality of power on self test (POST) codes to represent different POST stages. When the server enters a certain POST stage, the numerical value of the POST code that represents this stage is delivered to a particular IO port, for example, Port 80. The control chip 180 is coupled to the BIOS memory, and in the boot process of the server, outputs a boot inspection signal that is corresponding to the POST code and generated by the mainboard.

In this embodiment, the boot status detection unit 120 is coupled to the control chip 180 through, for example, a low pin count (LPC) interface, to receive the boot inspection signal generated by the control chip 180 and then to correspondingly generate a boot status detection signal BDS.

The control unit 130 is coupled to the power detection unit 110 and the boot status detection unit 120, and receives the power detection signal VDS and the boot status detection signal BDS to generate first control signals CS1_1 to CS1_8 and a second control signal CS2.

The first display unit 140 is coupled to the control unit 130, and receives and displays the first control signals CS1_1 to CS1_8. That is, the first display unit 140 generates a corresponding display status according to the first control signals CS1_1 to CS1_8.

Furthermore, the first display unit 140 comprises first LEDs 141, 142, 143, 144, 145, 146, 147 and 148 and first resistors R1_1, R1_2, R1_3, R1_4, R1_5, R1_6, R1_7 and R1_8. Cathode terminals of the first LEDs 141 to 148 are coupled to the control unit 130, and respectively receive the first control signals CS1_1 to CS1_8. First terminals of the first resistors R1_1 to R1_8 are one-to-one coupled to anode terminals of the first LEDs 141 to 148, and second terminals of the first resistors R1_1 to R1_8 are supplied with a duty voltage VCC, for example, P3V3_STBY.

When the first control signals CS1_1 to CS1_8 are high logic levels, the first LEDs 141 to 148 are turned off and do not emit light. When the first control signals CS1_1 to CS1_8 are low logic levels, the first LEDs 141 to 148 are turned on and emit light. The first display unit 140 shows whether an error occurs in the server.

The second display unit 150 is coupled to the control unit 130, and receives and displays the second control signal CS2. That is, the second display unit 150 generates a corresponding display status according to the second control signal CS2.

Furthermore, the second display unit 150 comprises a second LED 151 and a second resistor R2. A cathode terminal of the second LED 151 is coupled to the control unit 130, and receives the second control signal CS2. A first terminal of the second resistor R2 is coupled to an anode terminal of the second LED 151, and a second terminal of the second resistor R2 is supplied with a duty voltage VCC, for example, P3V3_STBY.

When the second control signal CS2 is a high logic level, the second LED 151 is turned off and does not emit light. When the second control signal CS2 is a low logic level, the second LED 151 is turned on and emits light. The second display unit 150 shows whether the server is in a POST stage. The detailed operation is described as follows.

In an embodiment, the power supply unit 170 starts supplying power and the server is started with an AC power (for example, AC-on) and a DC power (for example, DC-on), and if the power supply status of the power supply unit 170 is normal, the power detection unit 110 correspondingly generates a high logic level of a power detection signal VDS to the control unit 130. Since the server is in a power sequence stage and has not perform the self test stage of the BIOS yet, the control unit 130 does not receive the boot status detection signal BDS generated by the boot status detection unit 120.

Subsequently, according to the power detection signal VDS being a high logic level, the control unit 130 outputs low logic levels of the corresponding first control signals CS1_1 to CS1_8 to the first display unit 140, and outputs a high logic level of the second control signal CS2 to the second display unit. Thus, the first LEDs 141 to 148 of the first display unit 140 are turned on and emit light, and the second LED 151 of the second display unit 150 is turned off and does not emit light whereby the user may know that the server is in the power sequence stage as the first display unit 140 is in an on-status and the second display unit 150 is in an off-status.

After the power sequence stage of the server is completed, the BIOS enters the POST stage to output a corresponding numerical value of a POST code to a particular IO port, and the control chip 180 generates a boot inspection signal according to the numerical value of the POST code.

After receiving the boot inspection signal, the boot status detection unit 120 outputs a corresponding boot status detection signal BDS to the control unit 130. The control unit 130 correspondingly outputs a low logic level of the second control signal CS2 to the second display unit 150 according to the boot status detection signal BDS. Herein, the LED 151 of the second display unit 150 is turned on and emits light, and the control unit 130 outputs corresponding logic levels of the first control signals CS1_1 to CS1_8 to the first display unit 140 according to the boot status detection signal BDS, to generate a corresponding display status.

For example, when the POST code generated by the BIOS is “00001101”, the control chip 180 outputs a boot inspection signal of “00001101” to the boot status detection unit 120. Herein, the boot status detection unit 120 generates a boot status detection signal BDS of “00001101” to the control unit 130 according to the boot inspection signal of “00001101”.

The control unit 130 outputs high logic levels of the first control signals CS1_1, CS1_2, CS1_3, CS1_4 and CS1_7 and low logic levels of the first control signals CS1_5, CS1_6 and CS1_8 to the first display unit 140 according to the boot status detection signal BDS of “00001101”. Thus, the first LEDs 141 to 144 and 147 in the first display unit 140 are turned off and do not emit light, and the first LEDs 145, 146 and 148 in the first display unit 140 are turned on and emit light. That is, the displayed status of the first LEDs 141 to 148 in the first display unit 140 is “00001101”.

Therefore, the user may know that the server enters the POST stage as the second display unit 150 is in an on-status, and acquire the corresponding POST code of the POST stage according to the status of the boot status detection signal BDS of “00001101” displayed by the first display unit 140.

When an error occurs in the power supply unit 170, the power detection unit 110 detects that the power supply status of the power supply unit 170 is abnormal, and correspondingly outputs a low logic level of a power detection signal VDS to the control unit 130. According to the power detection signal VDS being a low logic level, the control unit 130 outputs low and high logic levels of the first control signals CS1_1 to CS1_8 repeatedly and sequentially to the first display unit 140, and outputs a high logic level of the second control signal CS2 to the second display unit 150.

The first LEDs 141 to 148 of the first display unit 140 are sequentially turned on and emit light as well as turned off and do not emit light, that is, the first display unit 140 is in a flickering status. The second LED 151 of the second display unit 150 is turned off and does not emit light, that is, the second display unit 150 is in an off-status. Therefore, the user may know that an error occurs in the power supply unit 170 as the first display unit 140 is in a flickering status and the second display unit 150 is in an off-status.

After being started with an AC power (that is, the server is connected to an AC power source), the server is further started with a DC power. When the server is waiting to be started with the DC power, the power detection unit 110 outputs a power detection signal VDS carrying, for example, an AC message, to the control unit 130. Afterward, the control unit 130 correspondingly generates low logic levels of the first control signals CS1_1 to CS1_8 sequentially to the first display unit 140 according to the power detection signal VDS, so that the first LEDs 141 to 148 in the first display unit 140 are sequentially turned on and emit light.

For example, when the first LED 141 is turned on and emits light, the first LEDs 142 to 148 are turned off and do not emit light. When the first LED 142 is turned on and emits light, the first LEDs 141 and 143 to 148 are turned off and do not emit light. The operation of the rest of the first LEDs can be deduced in the same way, so that the first display unit 140 is, for example, in a running strip status.

Therefore, the user may acquire that the server is waiting to be started with a DC power as the first display unit 140 is in a running strip status and the second display unit 150 is in an off-status.

It can be seen from the above description that, the corresponding relations among the display status of the first display unit 140, the display status of the second display unit 150 and the status of the server are shown in Table 1.

TABLE 1

| | Display status of | |
|---|---|---|
| Display status of the | the second display | |
| first display unit 140 | unit 150 | Status of the server |
| On-status | Off-status | Enter the power sequence stage |
| Status of the boot | On-status | Enter the POST stage |
| status detection signal | | |
| Flickering status | Off-status | An error occurs in the power |
| | | supply unit. |
| Running strip status | Off-status | Wait to be started with a DC |
| | | power |

It can be seen from Table 1 that, in this and some embodiments, the debugging device 100 shows the current operation stage of the server or shows whether an error occurs in a component, according to the display status of the first display unit 140 and the second display unit 150. In other word, in this and some embodiments, the debugging device 100 controls and switches between the first display unit 140 and the second display unit 150 through the control unit 130 to present corresponding display status, such as the status of entering the power sequence stage, the status of waiting to be started with a DC power, the status of entering the POST stage, the status of acquiring the corresponding POST code, and the power supply unit error status. Therefore, the user may acquire the operation status of the server through the display status of the first display unit 140 and the second display unit 150, to facilitate the maintenance of the server.

In the debugging device provided by the embodiment of the disclosure, the power detection unit detects the power supply status of the power supply unit to generate the power detection signal, the boot status detection unit detects the boot inspection signal generated by the control chip to generate the boot status detection signal, and the control unit controls the first display unit and the second display unit according to the power detection signal and the boot status detection signal to present the corresponding display status, that is, to present display status such as the status of entering the power sequence stage, the status of waiting to be started with a DC power, the status of entering the POST stage, the status of acquiring the corresponding POST code, and the power supply unit error status. Therefore, the debugging time, cost and execution difficulty of the server can be effectively reduced, and the debugging efficiency is improved.

What is claimed is:

1. A debugging device, adapted to a server having a power supply unit and a control chip, the debugging device comprising:
a power detection unit, coupled to the power supply unit, for detecting a power supply status of the power supply unit to generate a power detection signal;
a boot status detection unit, coupled to the control chip, for receiving a boot inspection signal to generate a boot status detection signal;
a control unit, coupled to the power detection unit and the boot status detection unit, for receiving the power detection signal and the boot status detection signal to generate a plurality of first control signals and a second control signal;
a first display unit, coupled to the control unit, for receiving and displaying the first control signals; and
a second display unit, coupled to the control unit, for receiving and displaying the second control signal.

2. The debugging device according to claim 1, wherein the first display unit comprises:
a plurality of first light-emitting diodes having a plurality of cathode terminals and a plurality of anode terminals , the plurality of cathode terminals being coupled to the control unit for receiving the first control signals; and
a plurality of first resistors, first terminals of the first resistors being one-to-one coupled to the plurality of anode terminals of the first light-emitting diodes, and a plurality of second terminals of the first resistors being supplied with a duty voltage.

3. The debugging device according to claim 1, wherein the second display unit comprises:
a second light-emitting diode, a cathode terminal of the second light-emitting diode being coupled to the control unit for receiving the second control signal; and
a second resistor, a first terminal of the second resistor being coupled to an anode terminal of the second light-emitting diode, and a second terminal of the second resistor being supplied with a duty voltage.

4. The debugging device according to claim 1, wherein the boot status detection unit receives the boot inspection signal generated by the control chip, through a low pin count interface.

5. The debugging device according to claim 1, wherein the power supply unit starts supplying power, the server is started with an alternating current power and a direct current power, the power detection unit outputs the corresponding power detection signal to the control unit if the power supply status of the power supply unit is normal, and then the control unit outputs high logic levels of the corresponding first control signals to make the first display unit being in a turn on status, and outputs a low logic level of the second control signal to make the second display unit being in a turn off status, to indicate that the server is in a power sequence stage.

6. The debugging device according to claim 1, wherein when the control chip generates the boot inspection signal, the boot status detection unit correspondingly outputs the boot status detection signal to the control unit in response to the boot inspection signal, and the control unit correspondingly outputs a high logic level of the second control signal according to the boot status detection signal to make the second display unit being in a turn on status, and outputs the first control signals according to the boot status detection signal to make the first display unit present a display status corresponding to the boot status detection signal, so as to indicate that the server enters a power on self test stage.

7. The debugging device according to claim 1, wherein when an error occurs in the power supply unit, the power detection unit detects that the power supply status of the power supply unit is abnormal and correspondingly outputs the power detection signal to the control unit, and according to the power detection signal, the control unit outputs low and high logic levels of the first control signals repeatedly and sequentially to make the first display unit being in a flickering status, and outputs a low logic level of the second control signal to make the second display unit being in a turn off status, so as to indicate that the error occurs in the power supply unit.

8. The debugging device according to claim 1, wherein when the server is started with an alternating current power, the power detection unit outputs the power detection signal carrying an alternating current message to the control unit, and according to the power detection signal, the control unit sequentially outputs high logic levels of the first control signals to make the first display unit being in a running trip status, and outputs a low logic level of the second control signal to make the second display unit being in a turn off status, so as to indicate that the server is waiting to be started with a direct current power.
